(19) United States
(12) Patent Application Publication
(10) Pub. No.: US 2007/0097020 A1
(43) Pub. Date: May 3, 2007

(54) Display device

(76) Inventor: Yoshifumi Sato, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/560,786

(22) PCT Filed: Aug. 25, 2004
(86) PCT No.: PCT/JP04/12184

§ 371 Date: Dec. 14, 2005

(30) Foreign Application Priority Data
Aug. 27, 2003 (JP) 2003-303105

(51) Int. Cl. G09G 5/00

(52) U.S. Cl. 345/3.1

(57) ABSTRACT

The display device can reduce a burden on a user. The display device includes a plurality of input terminals to receive a plurality of display signals, respectively. A digital input terminal is included in the input terminals. The display device also includes a display signal processing section to select one of the display signals. The display device also includes a first memory section to store first display specification information, a second memory section to store second display specification information, and a memory shift switch to connect the first or second memory section to the digital input terminal. The display device also includes a display control section to control the operation of the display signal processing section and the memory shift switch. The first and second display specifications information is specifications information for display signals introduced to the digital input terminal. The display control section controls the display signal processing section to select the display signal corresponding to the first display specifications information, and controls the memory shift switch to connect the first memory section to the digital input terminal. The display control section also controls the display signal processing section to select the display signal corresponding to the second display specifications information, and controls the memory shift switch to connect the second memory section to the digital input terminal.

### TECHNICAL FIELD

The present invention relates to a display device, and especially relates to a display device with a digital interface and a display method for use in the display device.

### BACKGROUND ART

A display device which has a digital interface and carries out display by processing a digital signal is used. The display device may be used with a PC (personal computer), or may be used with CE (consumer electronics) equipment. The CE equipment supplies a digital image signal to the display device. Typical CE equipment is an STB (set top box for a digital broadcast) and a DVD player. The display device which is provided with the digital interface corresponding to an input from the PC (hereinafter called PC equipment) or the CE equipment is desired.

The display device equipped with the digital interface often sends display specifications information to a host device. One example of the display specifications information is EDID (extended display identification data). The EDID includes the resolution of the display device, the information of a scan signal, a frame rate, a maker identifier, and an identifier of the display device. Referring to the EDID, the host device generates a digital signal in a format suited to the specifications of the display device. Such a function is generally called plug-and-play function.

Compatibility between EDID for the PC equipment and EDID for the CE equipment is not always ensured. The display device, to which the PC equipment or the CE equipment is connected, has to have the EDID for the CE equipment and the EDID for the PC equipment in accordance with the specifications of the host device (PC equipment/CE equipment). If the display device outputs proper EDID to the host device, the display device can obtain a proper digital signal (image signal) from the host device.

FIG. 1 of the accompanying drawings shows a display device (conventional display device) which supplies proper EDID to a host device, when a user operates a manual switch. The conventional display device includes a display device input section 110, a controller 120, and a display section (not shown). The display device input section 110 is connected to the controller 120. The controller 120 is connected to the display section.

The display device input section 110 includes a receiver section 116, a memory section for the CE equipment EDID 103, a memory section for the PC equipment EDID 104, memory shift switches 105 and 106, a manual switch 107, an analog video input processing section 108, an analog PC input processing section 109, analog video input terminals 111 and 112, analog PC input terminals 113 and 114, and a digital input terminal 115. The receiver section 116 has a receiver module for a contents protection system 101, and a receiver module for digital transmission 102. The controller 120 has a display signal processor 121 and a display controller 122.

The analog video input processing section 108 is connected to the analog video input terminals 111 and 112 and the display signal processing section 121. A host device (not shown) is connected to the analog video input terminal 111. The host device is connected to the analog video input terminal 112.

The analog PC input processing section 109 is connected to the analog PC input terminals 113 and 114 and the display signal processing section 121. The host device is connected to the analog PC input terminal 113. The host device is connected to the analog PC input terminal 114.

The receiver section 116 (the receiver module for the contents protection system 101 and the receiver module for digital transmission 102) is connected to the digital input terminal 115 and the display signal processing section 121. The digital input terminal 115 corresponds to the above-mentioned interface. The host device (CE equipment or PC equipment; not shown) is connected to the digital input terminal 115.

The EDID for the CE equipment is stored in the memory section for the CE equipment EDID 103. The EDID for the PC equipment is stored in the memory section for the PC equipment EDID 104.

The memory shift switch 105 is connected to the digital input terminal 115, the receiver section 116, the memory section for the CE equipment EDID 103, and the memory section for the PC equipment EDID 104. By switching the memory shift switch 105, either the memory section for the CE equipment EDID 103 or the memory section for the PC equipment EDID 104 is connected to the digital input terminal 115. The memory shift switch 106 is also connected to the digital input terminal 115, the receiver section 116, the memory section for the CE equipment EDID 103, and the memory section for the PC equipment EDID 104. By switching the memory shift switch 106, either the memory section 103 or the memory section 104 is connected to the digital input terminal 115. These memory shift switches 105 and 106 are connected to a data line and a clock line, respectively.

The user can operate the manual switch 107 to switch the memory shift switches 105 and 106. When the user operates the manual switch 107, connection is made between the memory section for the CE equipment EDID 103 and the digital input terminal 115, or connection is made between the memory section for the PC equipment EDID 104 and the digital input terminal 115.

The display signal processing section 121 is connected to the display section (not shown). The display control section 122 is connected to the display signal processing section 121. The display signal processing section 121 selects one display signal from among an analog video signal supplied from the analog video input processing section 108, an analog PC signal supplied from the analog PC input processing section- 109, a digital video signal supplied from the receiver section 101, and a digital PC signal supplied from the second receiver section 102. Then, the display signal processing section 121 subjects the selected display signal to proper signal processing, and feeds a processed signal to the display section. The display control section 122 carries out various setups so that the display signal processing section 121 can perform the proper signal processing.

When the user utilizes the host device and the analog video input terminal 111, an analog video signal is supplied from the host device to the analog video input processing section 108 through the analog video input terminal 111. The analog signal (analog video signal) is supplied from the analog video input processing section 108 connected to the analog video input terminal 111 to the display signal processing section 121. Then, the display signal processing section 121 generates an image signal for displaying the analog video signal on the display section, and supplies the image signal to the display section.

When the user uses the host device and the analog video input terminal 112, an analog video signal is sent from the host device to the analog video input processing section 108 through the analog video input terminal 112. The analog signal (analog video signal) is sent from the analog video input processing section 108 connected to the analog video input terminal 112 to the display signal processing section 121. Then, the display signal processing section 121 generates an image signal for displaying the analog video signal on the display section, and supplies the image signal to the display section.

When the user uses the host device and the analog PC input terminal 113, an analog PC signal is supplied from the host device to the analog PC input processing section 109 through the analog PC input terminal 113. The analog signal (analog PC signal) is transferred from the analog PC input processing section 109 connected to the analog PC input terminal 113 to the display signal processing section 121. Then, the display signal processing section 121 generates an image signal for displaying the analog PC signal on the display section, and supplies the image signal to the display section.

When the user uses the host device and the analog PC input terminal 114, an analog PC signal is supplied from the host device to the analog PC input processing section 109 through the analog PC input terminal 114. The analog signal (analog PC signal) is supplied from the analog PC input processing section 109 connected to the analog PC input terminal 114 to the display signal processing section 121. Then, the display signal processing section 121 generates an image signal for displaying the analog PC signal on the display section, and transfers the image signal to the display section.

When the user uses the host device (CE equipment) and the digital input terminal 115, the user operates the manual switch 107 to connect the digital input terminal 115 to the memory section for the CE equipment EDID 103. The receiver section corresponding to the contents protection system 101 is used, when the digital input terminal 115 is connected to the memory section 103 through the memory shift switches 105 and 106. When the host device (CE equipment) is connected to the digital input terminal 115, the host device and the receiver section 101 carry out key authentication to each other. When the keys are authenticated, the CE equipment refers to the CE equipment EDID stored in the memory section 103, and supplies a digital video signal to the digital input terminal 115 as a digital signal suited to the specifications of the conventional display device. The digital signal (digital video signal) is supplied from the CE equipment to the receiver section 101 through the digital input terminal 115.

The digital video signal from the CE equipment is encoded on the basis of the contents protection system. When broadcasting a digital image, a contents protection function is sometimes used to protect a copyright on contents. For example, HDCP (high bandwidth digital protection) suited for a DVI (digital visual interface) is used for the contents protection. To protect the contents, the digital signal is encoded and transmitted between the CE equipment and the conventional display device. The receiver section corresponding to the contents protection system 101 decodes the encoded digital video signal.

The digital signal (digital video signal) is supplied from the receiver section 101 connected to the digital input terminal 115 to the display signal processing section 121. The display signal processing section 121 generates an image signal for displaying the digital video signal on the display section, and supplies the image signal to the display section.

When the user uses the host device (PC equipment) and the digital input terminal 115, the user operates the manual switch 107 to connect the digital input terminal 115 to the memory section for the PC equipment EDID 104. The receiver section for digital transmission 102 is used, when the digital input terminal 115 is connected to the memory section 104 through the memory shift switches 105 and 106. When the host device (PC equipment) is connected to the digital input terminal 115, the host device refers to the PC equipment EDID stored in the memory section 104, and outputs a digital PC signal to the digital input terminal 115 as a digital signal suited to the specifications of the conventional display device.

The digital signal (digital PC signal) is supplied from the PC equipment to the receiver section 102 through the digital input terminal 115. The digital signal (digital PC signal) is introduced from the receiver section 102 connected to the digital input terminal 115 to the display signal processing section 121. The display signal processing section 121 generates an image signal for displaying the digital PC signal on the display section, and outputs the image signal to the display section.

When the user uses the CE equipment (host device) and the digital input terminal 115, the user has to switch the manual switch 107 in order to supply the CE equipment EDID to the conventional display device. If the user forgets to switch the manual switch 107, the proper digital signal (image signal) cannot be obtained from the CE equipment. When the user uses the PC equipment and the digital input terminal 115, the user has to switch the manual switch 107 in order to supply the PC equipment EDID to the conventional display device. If the user forgets to switch the manual switch 107, the proper digital signal (image signal) cannot be obtained from the PC equipment. Thus, a display device which can obtain a proper digital signal from the host device is desired. A display device which can always select proper display specifications information is desired, when a user uses the host device and a digital input terminal.

Japanese Patent Application Kokai (Laid-Open) No. 2001-175230 discloses a display device which displays an image on the basis of a group of signals introduced from a host. This display device has determination means, a plurality of storage means, and output means. The determination means determines the interface format of the host. The storage means store display specifications information on a connected-interface-format basis. The output means supplies the specifications information corresponding to the interface format concerned, from the storage means to the host on the basis of a determination result of the determination means.

Japanese Patent Kokai No. 2004-102067 discloses an image display device which can operate with a DDC (display data channel). This image display device has a single nonvolatile memory for the DDC, and control means. The control means writes EDID data of an input image signal, into the nonvolatile memory. This EDID data is selected from a plurality of EDED data for various types of image signal, on the basis of information indicating the type of input image signal.

When the display device has the single digital input terminal 115 and a plurality of analog input terminals (111 to 114), as shown in FIG. 1, the display signal processing section 121 has to select one of the input terminals, and accept an image signal (display signal) from the selected input terminal. The selection of the input terminal is also carried out on the basis of a command from the user. Specifically, when the user designates “video input” or “RGB input” by use of an operation button or the like, the display control section 122 controls the display signal processing section 121 so that the display signal processing section 121 selects the display signal supplied from the input terminal designated by the command.

A display device which can automatically select an input terminal and switch EDID without imposing a burden on a user is desired. When a display device is a digital device such as a liquid crystal display and a plasma display, it is predicted that demand for the display device equipped with a digital interface will increase in the future. Demand for a digital display device such as the plasma display will probably expand by solving the above described problems.

### SUMMARY OF THE INVENTION

One object of the present invention is to provide a display device which can obtain a proper display signal from a host device.

Another object of the present invention is to provide a display device which can certainly select proper display specifications information, when a user uses the host device and a digital input terminal.

Still another object of the present invention is to provide a display device which reduces a burden on the user so that the display device becomes easier for a user to use.

According to one aspect of the present invention, there is provided a display device that includes a plurality of input terminals to receive a plurality of display signals. The input terminals have a digital input terminal. The display device also includes a display signal processing section which selects one of the display signals received at the input terminals, a first memory section which stores first display specifications information, a second memory section which stores second display specifications information, and a memory shift switch which connects the first or second memory section to the digital input terminal. The display device also includes a display control section which controls the operation of the display signal processing section and the memory shift switch. The first and second display specifications information is specifications information for the display signals which are introduced to the digital input terminal. The display control section carries out a “first operation,” in which the display control section controls the display signal processing section so as to select the display signal corresponding to the first display specifications information, and controls the memory shift switch so as to connect the first memory section to the digital input terminal. The display control section carries out a “second operation,” in which the display control section controls the display signal processing section so as to select the display signal corresponding to the second display specifications information, and controls the memory shift switch so as to connect the second memory section to the digital input terminal.

According to the present invention, the selection of the input terminal by the display signal processing section is made in conjunction with the switching of the memory shift switch. Therefore, a burden on a user is reduced.

This display device further includes an operation section which the user operates. The operation section is connected to the display control section. The operation section has at least one input selection switch which is used by the user to select at least one of the input terminals. The display control section carries out at least one of the “first operation” and the “second operation” in accordance with the operation of the at least one input selection switch by the user.

In this display device, the input terminals may further include at least one analog video input terminal to receive an analog video signal and at least one analog PC input terminal to receive an analog PC signal. The operation section has a first input selection switch for selecting either the digital input terminal or the at least one analog video input terminal, and a second input selection switch for selecting either the digital input terminal or the at least one analog PC input terminal.

The display control section controls the display signal processing section so as to select the display signal from either the digital input terminal or the at least one analog video input terminal, in accordance with the operation of the first input selection switch by the user. Also, the display control section controls the display signal processing section so as to select the display signal from either the digital input terminal or the at least one analog PC input terminal, in accordance with the operation of the second input selection switch by the user. When the display signal from the digital input terminal is selected in accordance with the operation of the first input selection switch by the user, the display control section carries out the “first operation.” When the display signal from the digital input terminal is selected in accordance with the operation of the second input selection switch by the user, the display control section carries out the “second operation.”

In the display device of the present invention, the operation section may be connected to the display control section by radio.

According to the present invention, as described above, when the user uses the host device and the digital input terminal, a digital input selection signal is generated in accordance with operation by the user, so that proper display specifications information is selected. Thus, according to a display method of the present invention, it is possible to certainly select the proper display specifications information, when the user uses the host device and the digital input terminal. Because the proper display specifications information is selected, the host device can refer to the proper display specifications information and supply a digital signal suited to the specifications of the display signal to a digital image input terminal. Therefore, according to the display method of the present invention, it is possible to obtain the proper digital signal from the host device.

In the display device according to the present invention, the first display specifications information is, for example, EDID (extended display identification data) of consumer electronics equipment and the second display specifications information is, for example, EDID of a personal computer.

According to another aspect of the present invention, there is provided a display device that includes a plurality of input terminals, a display signal processing section, a first memory section which stores EDID for video, a second memory section which stores EDID for a PC, a memory shift switch, and an input selection switch which selects one of the input terminals The input terminals include one digital input terminal which receives a digital display signal, at least one analog video input terminal which receives an analog video signal, and at least one analog PC input terminal which receives an analog PC signal. The display signal processing section selects one of the input terminals, and carries out signal processing on a display signal supplied from the selected input terminal to display the display signal on the display section in a format suited to the display section. The memory shift switch connects the digital input terminal to the first or second memory section. At this time, the memory shift switch is switched in accordance with a selection result by the input selection switch, and the display signal processing section determines the display signal to be displayed on the display section.

According to still another aspect of the present invention, there is provided a display method for use with a display device. The display device has a plurality of input terminals including a digital input terminal to receive display signals, a first memory section to store first display specifications information, and a second memory section to store second display specifications information. This display method includes: (A) selecting the digital input terminal from the input terminals, when a user selects the first or second display specifications information; (B) connecting the first memory section to the digital input terminal when the first display specifications information is selected, and connecting the second memory section to the digital input terminal when the second display specifications information is selected; and (C) displaying the display signal, which is supplied from the selected digital input terminal and suited to the first display specifications information, when the first display specifications information is selected, and displaying the display signal, which is sent from the selected digital input terminal and suited to the second display specifications information, when the second display specifications information is selected.

In this display method, the first display specifications information is EDID of consumer electronics equipment, and the second display specifications information is EDID of a personal computer.

According to yet another aspect of the present invention, there is provided a display method that includes the steps of making a user select one input from a plurality of inputs including a digital input, making the user select one digital equipment group from a plurality of digital equipment groups when the user has selected the digital input, connecting a memory section which stores display specifications information of the selected digital equipment group to the digital input terminal, and displaying a display signal which is suited to the display specifications information supplied from the input terminal.

As described above, the display device of the present invention can obtain the proper display signal from the host device.

Also, the display device of the present invention can always select the proper display specifications information, when the user uses the host device and the digital input terminal.

Furthermore, the display device of the present invention reduces a burden on the user, and becomes easier for the user to use.

### BRIEF DESCRIPTION OF THE DRAWINGS

FIG. 1 shows the structure of a general display device (conventional technology);

FIG. 2 shows the structure of a display device according to the present invention (first to fourth embodiments);

FIG. 3 is a diagram showing CE equipment EDID which is stored in a memory section of the display device according to the present invention (first to fourth embodiments);

FIG. 4 is a diagram showing PC equipment EDID which is stored in another memory section of the display device according to the present invention (first to fourth embodiments);

FIG. 5 illustrates another structure of the display device according to the present invention (first to fourth embodiments);

FIG. 6 illustrates the structure of an operation section (first and second embodiments);

FIG. 7 is a flowchart showing the operation of the display device according to the present invention (first and second embodiments);

FIG. 8 is a flowchart showing PC input selection processing performed by the display device of the present invention (first embodiment);

FIG. 9 is a flowchart showing video input selection processing performed by the display device of the present invention (first embodiment);

FIG. 10 is a flowchart showing PC input selection processing performed by the display device of the present invention (second embodiment);

FIG. 11 is a flowchart showing video input selection processing performed by the display device of the present invention (second embodiment);

FIG. 12 is a diagram showing the structure of an operation section (third and fourth embodiments);

FIG. 13 is a flowchart showing the operation of the display device according to the present invention (third and fourth embodiments);

FIG. 14 is a flowchart showing processing when an RGB button is pressed, which is performed by the display device according to the present invention (third embodiment);

FIG. 15 is a flowchart showing processing when a video button is pressed, which is performed by the display device according to the present invention (third embodiment);

FIG. 16 is a flowchart of processing when the RGB button is pressed, which is performed by the display device according to the present invention (fourth embodiment); and

FIG. 17 is a flowchart of processing when the video button is pressed, which is performed by the display device according to the present invention (fourth embodiment).

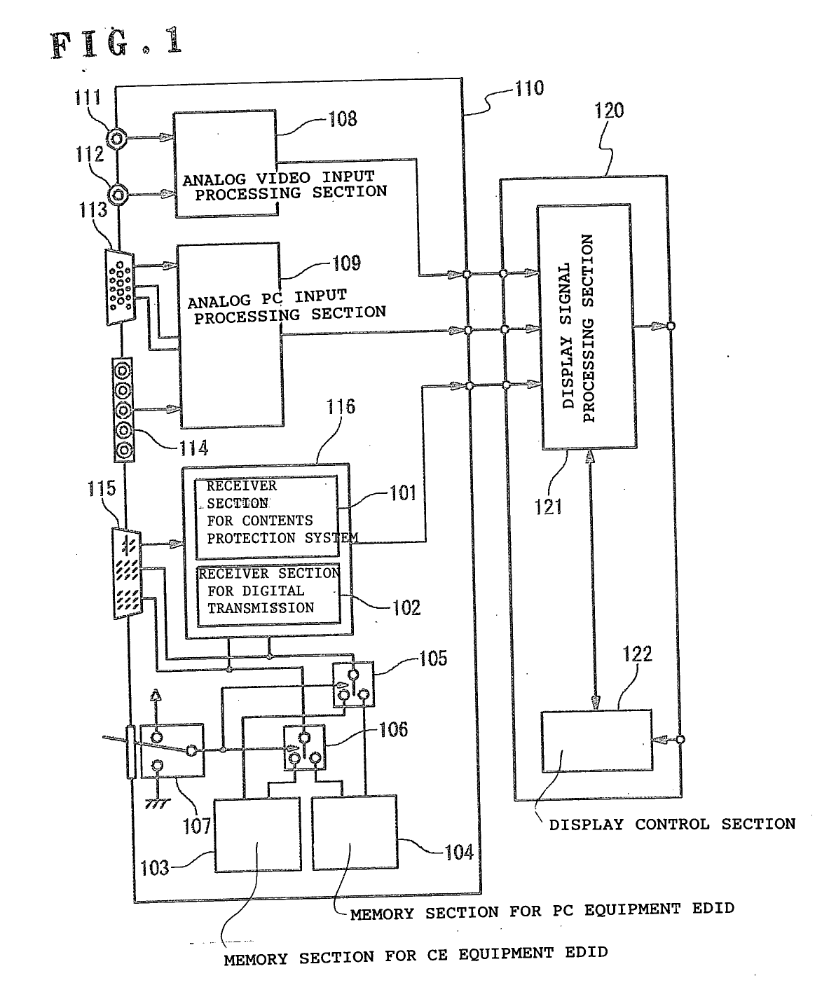

### BEST MODE FOR CARRYING OUT THE INVENTION

The best mode for implementing a display device according to the present invention will be hereinafter described with reference to the accompanying drawings.

### First Embodiment

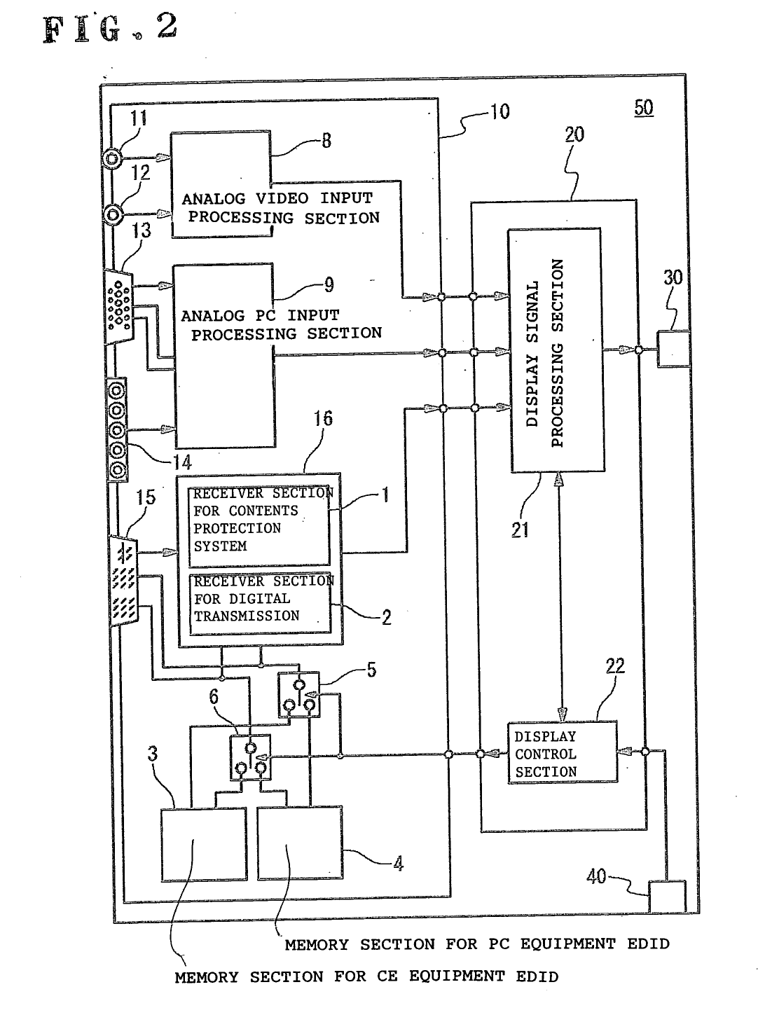

FIG. 2 is a diagram showing the structure of a display device 50 according to a first embodiment of the present invention. The display device 50 includes a display device input section 10, a controller 20, a display section 30, and an operation section 40. The display device input section 10 is connected to the controller 20. The controller 20 is connected to the display section 30 and the operation section 40. The display section 30 is, for example, a plasma display or a liquid crystal display.

The display device input section 10 is connected to a host device (not illustrated) outputting a digital signal, or a host device (not illustrated) outputting an analog signal. The display device input section 10 has a digital interface for connecting to the host device outputting the digital signal, and an analog interface for connecting to the host device outputting the analog signal. The host device outputting the digital signal is, for example, CE equipment (consumer electronics equipment; digital equipment group) or PC equipment (personal computer; digital equipment group). The digital interface is, for example, a DVI (digital visual interface). The CE equipment is, for example, an STB (set top box for digital broadcast) or a DVD player.

When the CE equipment is connected to the digital interface, the CE equipment supplies a digital video signal to the digital interface. When the PC equipment is connected to the digital interface, the PC equipment supplies a digital PC signal to the digital interface.

The display device input section 10 has a receiver section 16, a memory section for CE equipment EDID 3, a memory section for PC equipment EDID 4, memory shift switches 5 and 6, an analog video input processing section 8, an analog PC input processing section 9, analog video input terminals 11 and 12, analog PC input terminals 13 and 14, and a digital input terminal 15. The receiver section 16 includes a receiver for a contents protection system 1 and a receiver for digital transmission 2. The controller 20 has a display signal processing section 21 and a display control section 22. The display control section 22 is a microcomputer.

The analog video input processing section 8 is connected to the analog video input terminals 11 and 12 and the display signal processing section 21. The analog video input terminal 11 corresponds to the analog interface, and a host device (not shown) is connected to the analog video input terminal 11. The analog video input terminal 12 corresponds to the analog interface, and the host device is connected to the analog video input terminal 12.

The analog PC input processing section 9 is connected to the analog PC input terminals 13 and 14 and the display signal processing section 21. The analog PC input terminal 13 corresponds to the analog interface, and the host device is connected to the analog PC input terminal 13. The analog PC input terminal 14 corresponds to the analog interface, and the host device is connected to the analog PC input terminal 14.

The receiver section 16 (the receivers 1 and 2) is connected to the digital input terminal 15 and the display signal processing section 21. The digital input terminal 15 corresponds to the digital interface, and the CE equipment (host device) or the PC equipment (host device) is connected to the digital input terminal 15.

The CE equipment and the PC equipment have different display specifications from each other. In the memory section for the CE equipment EDID 3, EDID (extended display identification data) for the CE equipment is stored. The CE equipment EDID is display specifications information, which indicates the specifications of the display device 50 when the CE equipment is connected to the digital input terminal 15. The CE equipment EDID is information which includes at least one of the resolution of the display device 50 (display section 30), scan-signal-related information, a frame rate, a maker identifier (a vendor code) for identifying a maker, and an identifier (serial number) for identifying the display device 50 when the digital video signal from the CE equipment is displayed on the display device 50 (display section 30) (see FIG. 3). The scan-signal-related information of the CE equipment EDID includes a frequency of the scan signal when the CE equipment displays the digital video signal on the display device 50 (display section 30).

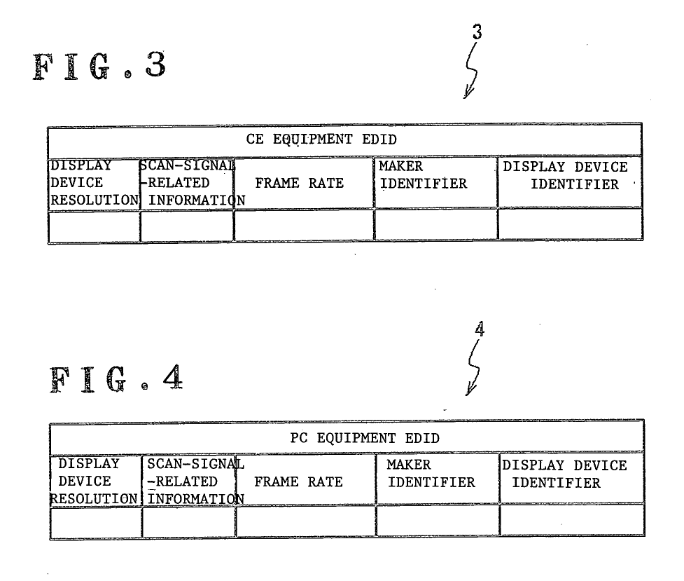

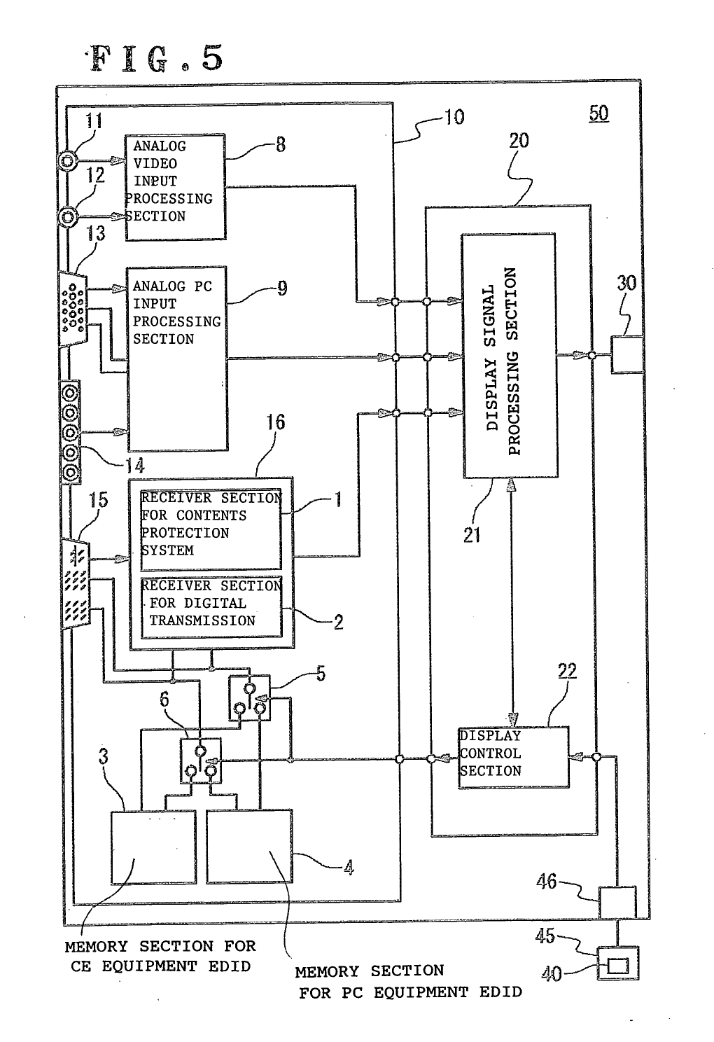

In the memory section for PC equipment EDID 4, EDID for the PC equipment is stored. The PC equipment EDID is display specifications information, which indicates the specifications of the display device 50 when the PC equipment is connected to the digital input terminal 15. The PC equipment EDID is information which includes at least one of the resolution of the display device 50 (display section 30), scan-signal-related information, a frame rate, a maker identifier (a vendor code), and an identifier (serial number) of the display device 50 (see FIG. 4) when the digital PC signal from the PC equipment is displayed on the display device 50 (display section 30). The scan-signal-related information of the PC equipment EDID includes a frequency of the scan signal when the PC equipment displays the digital PC signal on the display device 50 (display section 30).

The memory shift switch 5 is connected to the digital input terminal 15, the receiver section 16, the memory section for CE equipment EDID 3, and the memory section for PC equipment EDID 4. By switching the memory shift switch 5, either the memory section 3 or the memory section 4 is connected to the digital input terminal 15. The memory shift switch 6 is also connected to the digital input terminal 15, the receiver section 16, the memory section 3, and the memory section 4. By switching the memory shift switch 6, either the memory section 3 or the memory section 4 is connected to the digital input terminal 15. The memory shift switches 5 and 6 are connected to a data line and a clock line, respectively.

The display signal processing section 21 of the controller 20 is connected to the display section 30. The display control section 22 of the controller 20 is connected to the operation section 40, the display signal processing section 21, and the memory shift switches 5 and 6.

The display signal processing section 21 selects one display signal from among the analog video signal supplied from the analog video input processing section 8, the analog PC signal supplied from the analog PC input processing section 9, the digital video signal supplied from the receiver section 1, and the digital PC signal supplied from the receiver section 2. Then, the display signal processing section 21 subjects the selected display signal to proper signal processing, and supplies a processed signal to the display section 30.

The display control section 22 carries out various setups so that the display signal processing section 21 can carry out the proper signal processing. Specifically, the display control section 22 supplies an input terminal selection signal to the display signal processing section 21. The display signal processing section 21 selects one of the input terminals (11 to 15) in accordance with the input terminal selection signal, and receives a display signal from the selected input terminal.

In this embodiment, the display control section 22 switches the memory shift switches 5 and 6. Specifically, the display control section 22 causes the display signal processing section 21 to select the digital video signal from the receiver section 1, and outputs a control signal for selecting the memory section 3 to the memory shift switches 5 and 6. Accordingly, the memory shift switcher 5 and 6 are switched, and hence the digital input terminal 15 is connected to the CE equipment EDID memory 3. Alternatively, the display control section 22 causes the display signal processing section 21 to select the digital PC signal from the receiver section 2, and outputs a control signal for selecting the memory section 4 to the memory shift switches 5 and 6. In this case, the memory shift switches 5 and 6 are switched such that the digital input terminal 15 is connected to the memory section 4. In other words, the display control section 22 according to this embodiment not only causes the display signal processing section 21 to select a single proper input terminal out of the input terminals, but also perform the switching of the memory shift switches 5 and 6.

When using the host device and the analog video input terminal 11, a user operates the operation section 40. The display control section 22 outputs a first analog video input terminal selection signal to the display signal processing section 21 in accordance with the operation of the operation section 40 by the user. In this embodiment, the display device 50 carries out “VIDEO 1” selection processing.

In the “VIDEO 1” selection processing, the display signal processing section 21 selects the analog video input terminal 11 out of the analog video input terminals 11 and 12, the analog PC input terminals 13 and 14, and the digital input terminal 15 in accordance with the first analog video input terminal selection signal. When the host device is connected to the selected analog video input terminal 11, the host device supplies the analog video signal (i.e., the analog signal) to the analog video input processing section 8 through the analog video input terminal 11. The analog signal (analog video signal) is supplied from the analog video input processing section 8 connected to the analog video input terminal 11 into the display signal processing section 21. The display signal processing section 21 generates an image signal for displaying the analog video signal on the display section 30, and outputs the image signal to the display section 30.

When using the host device and the analog video input terminal 12, the user operates the operation section 40. The display control section 22 supplies a second analog video input terminal selection signal to the display signal processing section 21 in accordance with the operation of the operation section 40 by the user. In this embodiment, the display device 50 carries out “VIDEO 2” selection processing.

In the “VIDEO 2” selection processing, the display signal processing section 21 selects the analog video input terminal 12 out of the analog video input terminals 11 and 12, the analog PC input terminals 13 and 14, and the digital input terminal 15 in accordance with the second analog video input terminal selection signal. When the host device is connected to the selected analog video input terminal 12, the host device supplies the analog video signal (i.e., the analog signal) to the analog video input processing section 8 through the analog video input terminal 12. The analog signal (analog video signal) is issued from the analog video input processing section 8 connected to the analog video input terminal 12 into the display signal processing section 21. The display signal processing section 21 generates an image signal for displaying the analog video signal on the display section 30, and supplies the image signal to the display section 30.

When using the host device and the analog PC input terminal 13, the user operates the operation section 40. The display control section 22 supplies a first analog PC terminal selection signal to the display signal processing section 21 in accordance with the operation of the operation section 40 by the user. In this embodiment, the display device 50 carries out “RGB (red, green, and blue) 1” selection processing.

In the “RGB 1” selection processing, the display signal processing section 21 selects the analog PC input terminal 13 out of the analog video input terminals 11 and 12, the analog PC input terminals 13 and 14, and the digital input terminal 15 in accordance with the first analog PC terminal selection signal. When the host device is connected to the selected analog PC input terminal 13, the host device supplies the analog PC signal (i.e., the analog signal) to the analog PC input processing section 9 through the analog PC input terminal 13. The analog signal (analog PC signal) is supplied from the analog PC input processing section 9 connected to the analog PC input terminal 13 into the display signal processing section 21. The display signal processing section 21 generates an image signal for displaying the analog PC signal on the display section 30, and supplies the image signal to the display section 30.

When using the host device and the analog PC input terminal 14, the user operates the operation section 40. The display control section 22 supplies a second analog PC terminal selection signal to the display signal processing section 21 in accordance with the operation of the operation section 40 by the user. Then, the display device 50 carries out “RGB 2” selection processing.

In the “RGB 2” selection processing, the display signal processing section 21 selects the analog PC input terminal 14 out of the analog video input terminals 11 and 12, the analog PC input terminals 13 and 14, and the digital input terminal 15 in accordance with the second analog PC terminal selection signal. When the host device is connected to the selected analog PC input terminal 14, the host device supplies the analog PC signal (i.e., the analog signal) to the analog PC input processing section 9 through the analog PC input terminal 14. The analog signal (analog PC signal) is supplied from the analog PC input processing section 9 connected to the analog PC input terminal 14 into the display signal processing section 21. The display signal processing section 21 generates an image signal for displaying the analog PC signal on the display section 30, and supplies the image signal to the display section 30.

When using the host device (CE equipment; not shown) and the digital input terminal 15, the user operates the operation section 40. The display control section 22 generates a digital video input selection signal to the display signal processing section 21 in accordance with the operation of the operation section 40 by the user. Furthermore, the display control section 22 supplies a control signal to the memory shift switches 5 and 6 to select the CE equipment EDID memory 3. Then, the display device 50 simultaneously carries out “RGB 3/VIDEO 3 (video input mode)” selection processing and CE equipment EDID memory selection processing.

In the “RGB 3/VIDEO 3 (video input mode)” selection processing, the display signal processing section 21 selects the digital input terminal 15 out of the analog video input terminals 11 and 12, the analog PC input terminals 13 and 14, and the digital input terminal 15 in accordance with the digital video input selection signal.

In the CE equipment EDID memory selection processing, the memory shift switches 5 and 6 are switched in accordance with the control signal from the display control section 22, so that the memory section 3 is connected to the digital input terminal 15. The receiver section for the contents protection system 1 is used, when the CE equipment EDID memory selection processing is carried out (when the digital input terminal 15 is connected to the memory section 3 through the memory shift switches 5 and 6). When the CE equipment (not illustrated) is connected to the selected digital input terminal 15, the CE equipment and the receiver section 1 carry out key authentication to each other. When the keys are authenticated, the CE equipment refers to the CE equipment EDID stored in the memory section 3, and sends a digital video signal to the digital input terminal 15 as a digital signal suited to the specifications of the display device 50.

In the “RGB 3/VIDEO 3 (video input mode)” selection processing, the digital signal (digital video signal) is sent from the CE equipment to the receiver section 1 through the digital input terminal 15. The digital video signal from the CE equipment is encoded on the basis of the contents protection system. When broadcasting a digital image, a contents protection function may be utilized to protect the copyright of contents. For instance, HDCP (high bandwidth digital protection) corresponding to the DVI (digital visual interface) may be utilized. To protect the contents, the digital signal which is encoded by use of the HDCP is transmitted between the CE equipment and the display device 50. The receiver section for the contents protection system 1 decodes the encoded digital video signal.

The digital signal (digital video signal) is issued from the receiver section 1 connected to the digital input terminal 15 into the display signal processing section 21. The display signal processing section 21 generates an image signal for displaying the digital video signal on the display section 30, and sends the image signal to the display section 30.

When using the host device (PC equipment; not shown) and the digital input terminal 15, the user operates the operation section 40. The display control section 22 sends a digital PC input selection signal to the display signal processing section 21 in accordance with the operation of the operation section 40 by the user. Furthermore, the display control section 22 sends a control signal to the memory shift switches 5 and 6 to select the PC equipment EDID memory 4. The display device 50 simultaneously carries out “RGB 3/VIDEO 3 (PC input mode)” selection processing and PC equipment EDID memory selection processing.

In the “RGB 3/VIDEO 3 (PC input mode)” selection processing, the display signal processing section 21 selects the digital input terminal 15 out of the analog video input terminals 11 and 12, the analog PC input terminals 13 and 14, and the digital input terminal 15 in accordance with the digital PC input selection signal.

In the PC equipment EDID memory selection processing, the memory shift switches 5 and 6 are switched in accordance with the control signal from the display control section 22, so that the memory section 4 is connected to the digital input terminal 15. The receiver section for digital transmission 2 is used, when the PC equipment EDID memory selection processing is carried out (when the digital input terminal 15 is connected to the memory section 4 through the memory shift switches 5 and 6). When the PC equipment is connected to the selected digital input terminal 15, the PC equipment refers to the PC equipment EDID stored in the memory section 4, and outputs a digital PC signal to the digital input terminal 15 as a digital signal suited to the specifications of the display device 50.

In the “RGB 3/VIDEO 3 (PC input mode)” selection processing, the digital signal (digital PC signal) is transferred from the PC equipment to the receiver section 2 through the digital input terminal 15. The digital signal (digital PC signal) is issued from the receiver section 2 connected to the digital input terminal 15 into the display signal processing section 21. The display signal processing section 21 generates an image signal for displaying the digital PC signal on the display section 30, and outputs the image signal to the display section 30.

Conventionally, when a user uses a host device (PC equipment or CE equipment) and the digital input terminal 115, the user has to switch the manual switch 107 in order to make the host device (PC equipment or CE equipment) refer to proper EDID (EDID for PC equipment or EDID for CE equipment). Accordingly, if the user forgets to switch the manual switch 107, it is impossible to obtain a proper digital signal from the host device (PC equipment or CE equipment). Also, the user has to conduct another operation, i.e., make a display signal processing section 121 select one of the input terminals (111 to 115).

In the display device 50 according to the first embodiment of the present invention, the selection of the input terminal (11 to 15) by the display signal processing section 21 is conducted in conjunction with the switching of the memory shift switches 5 and 6. Specifically, when the user uses the host device (PC equipment or CE equipment) and the digital input terminal 15, the user operates the operation section 40. In accordance with the user's operation, the display control section 22 sends the input selection signal (digital video input selection signal) to the display signal processing section 21, and also sends the control signal for selecting the CE equipment EDID to the memory shift switches 5 and 6. Alternatively, the display control section 22 outputs the input selection signal (digital PC input selection signal) to the display signal processing section 21, and also outputs the control signal for selecting the PC equipment EDID to the memory shift switches 5 and 6. Therefore, according to the display device 50 of the first embodiment of the present invention, it is possible to certainly select the proper EDID, when the user uses the host device (PC equipment or CE equipment) and the digital input terminal 15. Furthermore, since the selection of the EDID is performed in conjunction with the selection of the input terminal (11 to 15), a burden on the user is reduced.

According to the display device 50 of the first embodiment of the present invention, the proper EDID is selected so that the host device (PC equipment or CE equipment) can supply the digital signal suited to the specifications of the display device 50 to the digital image input terminal 15 with reference to the proper EDID. Thus, the display device 50 according to the first embodiment of the present invention can obtain the proper digital signal from the host device (PC equipment or CE equipment).

FIG. 5 is a diagram showing a modification to the display device 50 according to the first embodiment of the present invention. The operation section 40 is provided in a main body of the display device 50 in the foregoing description, but may be provided in a remote control terminal 45 as shown in FIG. 5. In this case, the display device 50 is provided with a receiver section 46 instead of the operation section 40, and the remote control terminal 45 is provided with the operation section 40. The remote control terminal 45 communicates with the main body (display device 50) in a wired or wireless manner. The receiver section 46 connected to the display control section 22 supplies a signal to the display control section 22 in accordance with operation from the operation section 40 by the user.

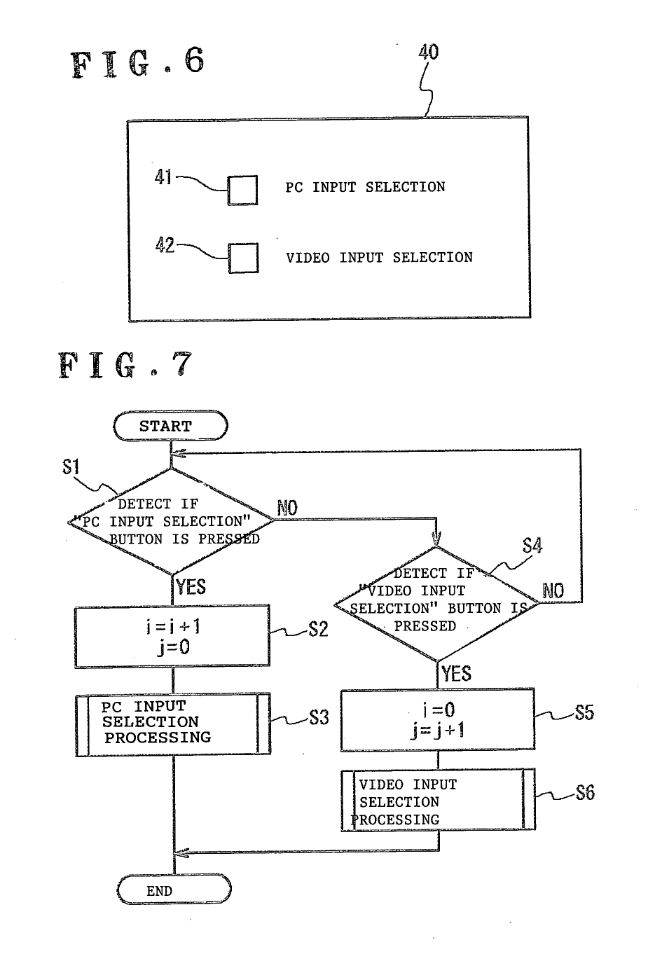

FIG. 6 is a diagram showing the structure of the operation section 40. The operation section 40 has a “PC INPUT SELECTION” button 41 and a “VIDEO INPUT SELECTION” button 42. The display control section 22 has a PC input counter (not shown) and a video input counter (not shown).

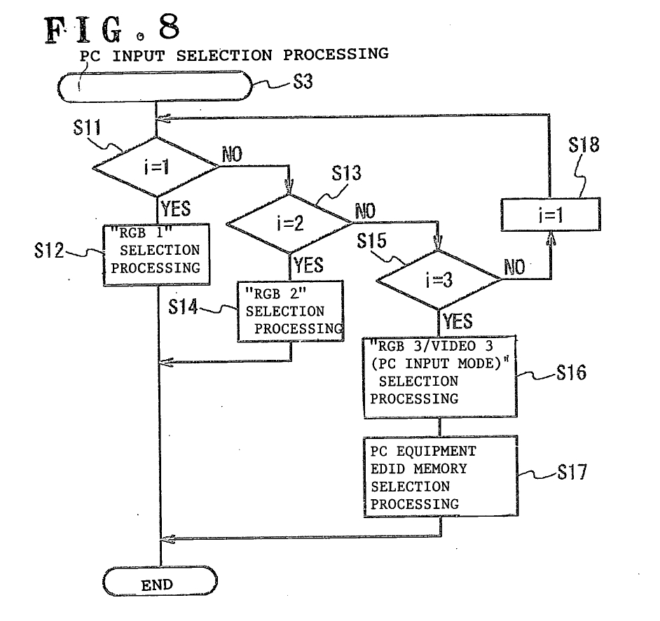

FIG. 7 is a flowchart showing the operation of the display device 50 according to the first embodiment of the present invention. Ever time the user presses the “PC INPUT SELECTION” button 41 of the operation section 40 (step S1—YES), the display control section 22 increments a count number i of the PC input counter by 1, and clears a count number j of the video input counter (step S2). Then, the display device 50 carries out PC input selection processing (step S3).

Every time the user presses the “VIDEO INPUT SELECTION” button 42 of the operation section 40 (step S1—NO and S4—YES), the display control section 22 clears the count number i of the PC input counter, and increments the count number j of the video input counter by 1 (step S5). In this case, the display device 50 carries out video input selection processing (step S6).

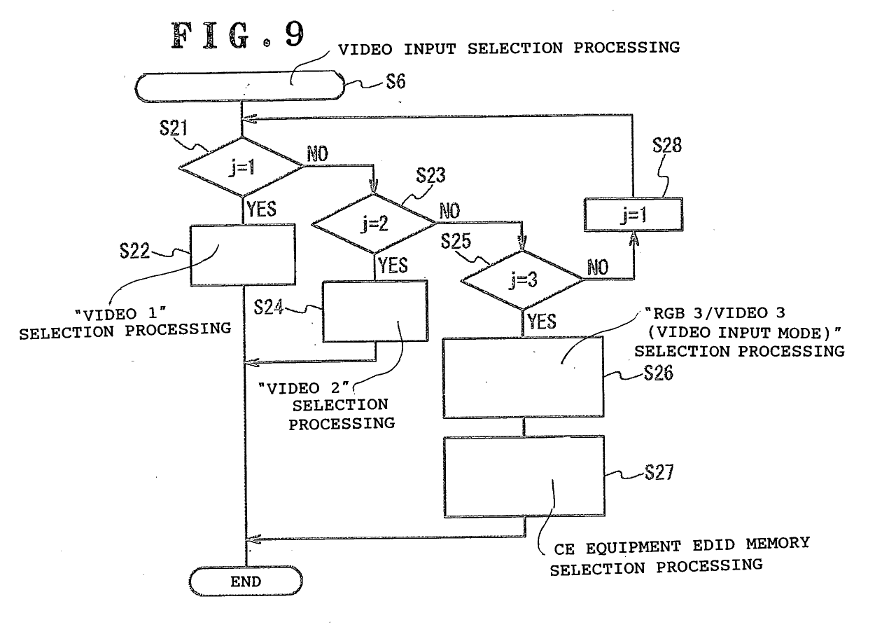

FIG. 8 is a flowchart of the PC input selection processing (step S3) performed by the display device 50 according to the first embodiment of the present invention. When the count number i of the PC input counter is 1, i.e., when the user has pressed the “PC INPUT SELECTION” button 41 of the operation section 40 once (step S11—YES), the display control section 22 sends the first analog PC terminal selection signal to the display signal processing section 21. Then, the display device 50 carries out the “RGB 1” selection processing (step S12).

In the “RGB 1” selection processing (step S12), the display signal processing section 21 selects the analog PC input terminal 13 out of the analog video input terminals 11 and 12, the analog PC input terminals 13 and 14, and the digital input terminal 15 in accordance with the first analog PC terminal selection signal. Accordingly, when the analog PC signal is supplied from the analog PC input processing section 9 connected to the analog PC input terminal 13 into the display signal processing section 21, the display signal processing section 21 can generate the image signal for displaying the analog PC signal on the display section 30 and outputs the image signal to the display section 30. The display signal processing section 21 displays, for example, “RGB 1” in a predetermined position of the display section 30 so as to inform the user that an analog PC input image from the analog PC input terminal 13 is displayed.

When the count number i of the PC input counter is 2, in other words, when the user has pressed the “PC INPUT SELECTION” button 41 of the operation section 40 once more (twice) (step S11—NO and S13—YES), the display control section 22 outputs the second analog PC terminal selection signal to the display signal processing section 21. Then, the display device 50 carries out the “RGB 2” selection processing (step S14).

In the “RGB 2” selection processing (step S14), the display signal processing section 21 selects the analog PC input terminal 14 out of the analog video input terminals 11 and 12, the analog PC input terminals 13 and 14, and the digital input terminal 15 in accordance with the second analog PC terminal selection signal. Accordingly, when the analog PC signal is introduced from the analog PC input processing section 9 connected to the analog PC input terminal 14 into the display signal processing section 21, the display signal processing section 21 can generate the image signal for displaying the analog PC signal on the display section 30 and outputs the image signal to the display section 30. The display signal processing section 21 displays, for example, “RGB 2” in a predetermined position of the display section 30, for the purpose of informing the user that an analog PC input image from the analog PC input terminal 14 is displayed.

When the count number i of the PC input counter is 3, in other words, when the user has pressed the “PC INPUT SELECTION” button 41 of the operation section 40 once more (three times) (step S11—NO, S13—NO, and S15—YES), the display control section 22 supplies the digital PC input selection signal to the display signal processing section 21, and supplies the control signal to the memory shift switches 5 and 6. Then, the display device 50 simultaneously carries out the “RGB 3/VIDEO 3 (PC input mode)” selection processing (step S16) and the PC equipment EDID memory selection processing (step S17).

In the “RGB 3/VIDEO 3 (PC input mode)” selection processing (step S16), the display signal processing section 21 selects the digital input terminal 15 out of the analog video input terminals 11 and 12, the analog PC input terminals 13 and 14, and the digital input terminal 15 in accordance with the digital PC input selection signal.

In the PC equipment EDID memory selection processing (step S17), the memory shift switches 5 and 6 are switched in accordance with the control signal, and the digital input terminal 15 is connected to the memory section 4. When the PC equipment is connected to the selected digital input terminal 15, the PC equipment refers to the PC equipment EDID stored in the memory section 4, and outputs the digital PC signal to the digital input terminal 15 as the digital signal suited to the specifications of the display device 50.

In the “RGB 3/VIDEO 3 (PC input mode)” selection processing (step S16), the digital PC signal is introduced from the receiver section 2 connected to the digital input terminal 15 into the display signal processing section 21. The display signal processing section 21 generates the image signal for displaying the digital PC signal on the display section 30, and supplies the image signal to the display section 30. The display signal processing section 21 displays, for example, “RGB 3/VIDEO 3 (PC input mode)” in a predetermined position of the display section 30, for the purpose of informing the user that a digital PC input image from the digital input terminal 15 is displayed.

When the count number i of the PC input counter is 4, in other words, when the user has pressed the “PC INPUT SELECTION” button 41 of the operation section 40 once more (four times) (step S11—NO, S13—NO, and S15—NO), the display control section 22 sets the count number i of the PC input counter at 1 (step S18), and carries out the step S11.

FIG. 9 is a flowchart showing the video input selection processing (step S6) performed by the display device 50 according to the first embodiment of the present invention. When the count number j of the video input counter is 1, in other words, when the user has pressed the “VIDEO INPUT SELECTION” button 42 of the operation section 40 once (step S21—YES), the display control section 22 sends the first analog video terminal selection signal to the display signal processing section 21. Then, the display device 50 carries out the “VIDEO 1” selection processing (step S22).

In the “VIDEO 1” selection processing (step S22), the display signal processing section 21 selects the analog video terminal 11 out of the analog video input terminals 11 and 12, the analog PC input terminals 13 and 14, and the digital input terminal 15 in accordance with the first analog video terminal selection signal. Accordingly, when the analog video signal is supplied from the analog video input processing section 8 connected to the analog video terminal 11 into the display signal processing section 21, the display signal processing section 21 can generate the image signal for displaying the analog video signal on the display section 30 and sends the image signal to the display section 30. The display signal processing section 21 displays, for example, “VIDEO 1” in a predetermined position of the display section 30, for the purpose of informing the user that an analog video input image from the analog video input terminal 11 is displayed.

When the count number j of the video input counter is 2, in other words, when the user has pressed the “VIDEO INPUT SELECTION” button 42 of the operation section 40 once more (twice) (step S21—NO and S23—YES), the display control section 22 supplies the second analog video terminal selection signal to the display signal processing section 21. Then, the display device 50 carries out the “VIDEO 2” selection processing (step S24).

In the “VIDEO 2” selection processing (step S24), the display signal processing section 21 selects the analog video terminal 12 out of the analog video input terminals 11 and 12, the analog PC input terminals 13 and 14, and the digital input terminal 15 in accordance with the second analog video terminal selection signal. Accordingly, when the analog video signal is supplied from the analog video input processing section 8 connected to the analog video terminal 12 into the display signal processing section 21, the display signal processing section 21 can generate the image signal for displaying the analog video signal on the display section 30 and supplies the image signal to the display section 30. Then, the display signal processing section 21 displays, for example, “VIDEO 2” in a predetermined position of the display section 30, for the purpose of informing the user that an analog video input image from the analog video input terminal 12 is displayed.

When the count number j of the video input counter is 3, in other words, when the user has pressed the “VIDEO INPUT SELECTION” button 42 of the operation section 40 once more (three times) (step S21—NO, S23—NO, and S25—YES), the display control section 22 supplies the digital video input selection signal to the display signal processing section 21, and supplies the control signal to the memory shift switches 5 and 6. The display device 50 simultaneously carries out the “RGB 3/VIDEO 3 (video input mode)” selection processing (step S26) and the CE equipment EDID memory selection processing (step S27).

In the “RGB 3/VIDEO 3 (video input mode)” selection processing (step S26), the display signal processing section 21 selects the digital input terminal 15 out of the analog video input terminals 11 and 12, the analog PC input terminals 13 and 14, and the digital input terminal 15 in accordance with the digital video input selection signal.

In the CE equipment EDID memory selection processing (step S27), the memory shift switches 5 and 6 are switched in accordance with the control signal, and the digital input terminal 15 is connected to the memory section 3. When the CE equipment is connected to the selected digital input terminal 15, the CE equipment refers to the CE equipment EDID stored in the memory section 3, and outputs the digital video signal to the digital input terminal 15 as the digital signal suited to the specifications of the display device 50.

In the “RGB 3/VIDEO 3 (video input mode)” selection processing (step S26), the digital video signal is issued from the receiver section 1 connected to the digital input terminal 15 into the display signal processing section 21. The display signal processing section 21 generates the image signal for displaying the digital video signal on the display section 30, and outputs the image signal to the display section 30. Then, the display signal processing section 21 displays, for example, “RGB 3/VIDEO 3 (video input mode)” in a predetermined position of the display section 30, for the purpose of informing the user that a digital video input image from the digital input terminal 15 is displayed.

When the count number j of the video input counter is 4, in other words, when the user has pressed the “VIDEO INPUT SELECTION” button 42 of the operation section 40 once more (four times) (step S21—NO, S23—NO, and S25—NO), the display control section 22 sets the count number j of the video input counter at 1 (step S28), and carries out the step S21.

The display control section 22 carries out the step S18 and proceeds to the step S11, when the user presses the “PC INPUT SELECTION” button 41 of the operation section 40 four times. The display control section 22 may carry out the step S18 and proceed to the step S11, when the user presses the “PC INPUT SELECTION” button 41 of the operation section 40 for a certain (predetermined) period of time. The display control section 22 carries out the step S28 and shifts to the step S21, when the user presses the “VIDEO INPUT SELECTION” button 42 of the operation section 40 four times. The display control section 22 may carry out the step S28 and shift to the step S21, when the user presses the “VIDEO INPUT SELECTION” button 42 of the operation section 40 for a certain (predetermined) period of time.

In the PC input selection processing (step 3), the order of carrying out the “RGB 1” selection processing (step S12), the “RGB 2” selection processing (step S14), the “RGB 3/VIDEO 3 (PC input mode)” selection processing (step S16), and the PC equipment EDID memory selection processing (step S17) is fixed. It should be noted, however, that this order is just an example for carrying out the invention, and is flexibly changeable.

In the video input selection processing (step S6), the order of carrying out the “VIDEO 1” selection processing (step S22), the “VIDEO 2” selection processing (step S24), the “RGB 3/VIDEO 3 (video input mode)” selection processing (step S26), and the CE equipment EDID memory selection processing (step S27) is fixed. It should be noted, however, that this order is just an example for carrying out the invention, and is flexibly changeable.

In the step S2, the count number j of the video input counter is cleared. It should be noted that the count number j may be held; not cleared. In the step S5, likewise, the count number i of the PC input counter is cleared, but the count number i may be held.

According to the display device 50 of the first embodiment of the present invention, the selection of the input terminal (11 to 15) is made in conjunction with the selection of the EDID memory (3 and 4). Thus, a burden on the user is reduced. Therefore, it is possible to provide the display device 50 which is easy for the user to use. The user only has to operate the “PC INPUT SELECTION” button 41 or the “VIDEO INPUT SELECTION” button 42 of the operation section 40, and does not have to operate the manual switch. If the user operates the operation section 40 (“PC INPUT SELECTION” button 41 or “VIDEO INPUT SELECTION” button 42) on the remote controller 45, the user can control the display device 50 from a remote place, so that a burden on the user is further reduced. Also, when the proper EDID is selected, the kind of the input signal is displayed on the display section 30 of the display device 50. Therefore, it is possible to provide the display device 50 which is much easier for the user to use.

According to the display device 50 of the first embodiment of the present invention, when the user uses the host device (PC equipment or CE equipment) and the digital input terminal 15, the display control section 22 selects the PC equipment EDID in accordance with the operation by the user, or the display control section 22 selects the CE equipment EDID in accordance with the operation by the user. Thus, the display device 50 according to the first embodiment of the present invention can certainly select the proper EDID, when the user uses the host device (PC equipment or CE equipment) and the digital input terminal 15.

The display device 50 of the first embodiment of the present invention selects the proper EDID so that the host device (PC equipment or CE equipment) can refer to the proper EDID and send the digital signal suited to the specifications of the display device 50 to the digital image input terminal 15. Therefore, the display device 50 of the first embodiment of the present invention can obtain the proper digital signal from the host device (PC equipment or CE equipment).

### Second Embodiment

The PC input selection processing (step S3) performed by the display device 50 according to a second embodiment of the present invention is different from the first embodiment. Specifically, pressing the “PC INPUT SELECTION” button 41 of the operation section 40 switches the digital PC input image into the digital video input image. The video input selection processing (step S6) performed by the display device 50 according to the second embodiment of the present invention is also different from the first embodiment. Specifically, pressing the “VIDEO INPUT SELECTION” button 42 of the operation section 40 switches the digital video input image into the digital PC input image. In the following description of the display device 50 according to the second embodiment of the present invention, description overlapping the first embodiment is omitted.

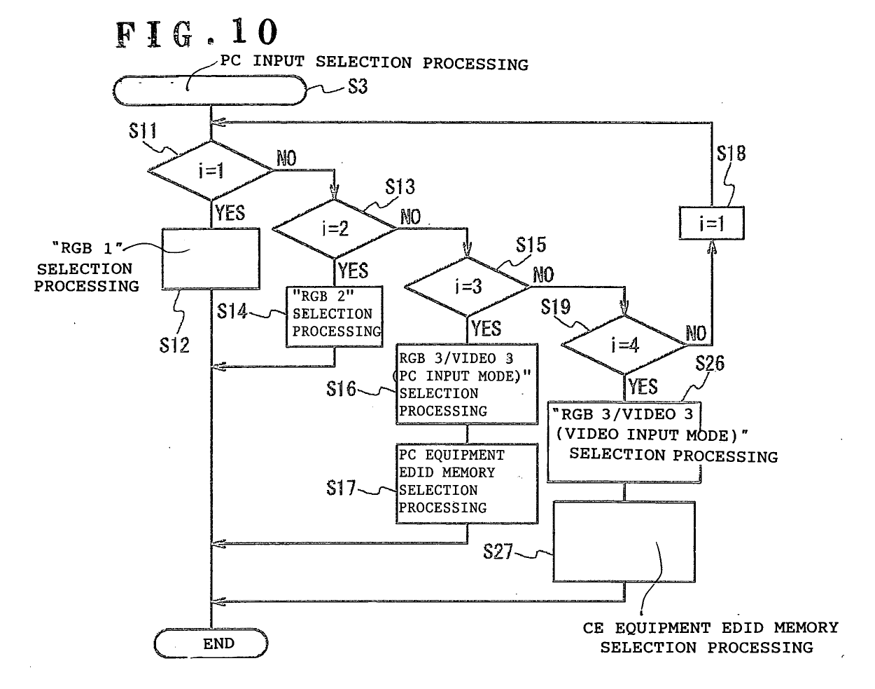

FIG. 10 is a flowchart showing the PC input selection processing (step S3) performed by the display device 50 according to the second embodiment of the present invention. When the count number i of the PC input counter is 4, i.e., when the user has pressed the “PC INPUT SELECTION” button 41 of the operation section 40 once more (four times) (step S11—NO, S13—NO, S15—NO, and S19—YES), the display device 50 simultaneously carries out “RGB 3/VIDEO 3 (video input mode)” selection processing (step S26) and CE equipment EDID memory selection processing (step S27), which are the same as those in the first embodiment.

When the count number i of the PC input counter is 5, i.e., when the user has pressed the “PC INPUT SELECTION” button 41 of the operation section 40 once more (five times) (step S11—NO, S13—NO, S15—NO, and S19—NO), the display control section 22 sets the count number i of the PC input counter at 1 (step S18), and carries out step S11.

FIG. 11 illustrates a flowchart of the video input selection processing (step S6) carried out by the operation of the display device 50 according to the second embodiment of the present invention.

When the count number j of the PC input counter is 4, i.e., when the user has pressed the “VIDEO INPUT SELECTION” button 42 of the operation section 40 once more (four times) (step S21—NO, S23—NO, S25—NO, and S29—YES), the display device 50 simultaneously carries out “RGB 3/VIDEO 3 (PC input mode)” selection processing (step S16) and PC equipment EDID memory selection processing (step S17), which are the same as those in the first embodiment.

When the count number j of the PC input counter is 5, i.e., when the user has pressed the “VIDEO INPUT SELECTION” button 42 of the operation section 40 once more (five times) (step S21—NO, S23—NO, S25—NO, and S29—NO), the display control section 22 sets the count number j of the video input counter at 1 (step S28), and carries out the step S21.

The display control section 22 carries out the step S18 and advances to the step S11, when the user has pressed the “PC INPUT SELECTION” button 41 of the operation section 40 five times. It should be noted, however, that the display control section 22 may carry out the step S18 and advance to the step S11, when the user presses the “PC INPUT SELECTION” button 41 of the operation section 40 for a certain (predetermined) period of time. The display control section 22 carries out the step S28 and proceeds to the step S21, when the user has pressed the “VIDEO INPUT SELECTION” button 42 of the operation section 40 five times. It should be noted, however, that the display control section 22 may carry out the step S28 and proceed to the step S21, when the user presses the “PC INPUT SELECTION” button 42 of the operation section 40 for a certain (predetermined) period of time.

In the PC input selection processing (step S3), the order of carrying out the “RGB 1” selection processing (step S12), the “RGB 2” selection processing (step S14), the “RGB 3/VIDEO 3 (PC input mode)” selection processing (step S16), the PC equipment EDID memory selection processing (step S17), the “RGB 3/VIDEO 3 (video input mode)” selection processing (step S26), and the CE equipment EDID memory selection processing (step S27) is fixed. It should be noted that this order is just an example for carrying out the invention, and is flexibly changeable.

In the video input selection processing (step S6), the order of carrying out the “VIDEO 1” selection processing (step S22), the “VIDEO 2” selection processing (step S24), the “RGB 3/VIDEO 3 (video input mode)” selection processing (step S26), the CE equipment EDID memory selection processing (step S27), the “RGB 3/VIDEO 3 (PC input mode)” selection processing (step S16), and the PC equipment EDID memory selection processing (step S17) is fixed. The order is just an example for carrying out the invention, and is flexibly changeable.

According to the display device 50 of the second embodiment of the present invention, when the user uses the host device (PC equipment; not shown) and the digital input terminal 15, the user is only required to operate the “PC INPUT SELECTION” button 41 of the operation section 40. When the user uses the host device (CE equipment; not shown) and the digital input terminal 15, the user is only required to operate the “PC INPUT SELECTION” button 41 of the operation section 40 again. When the user uses the host device (CE equipment) and the digital input terminal 15, the user is only required to operate the “VIDEO INPUT SELECTION” button 42 of the operation section 40. When the user uses the host device (PC equipment) and the digital input terminal 15, the user is only required to operate the “VIDEO INPUT SELECTION” button 42 of the operation section 40 again. According to the display device 50 of the second embodiment of the present invention, as described above, the user operates the same button to switch between the PC equipment and the CE equipment. Thus, in addition to the advantage of the first embodiment, a burden on the user is further reduced, and the display device 50 becomes easier for the user to use.

### Third Embodiment

The display device 50 according to a third embodiment of the present invention directly switches among the analog PC input image from the analog PC input terminal 13, the analog PC input image from the analog PC input terminal 14, the digital PC input image from the digital input terminal 15, the analog video input image from the analog video input terminal 11, the analog video input image from the analog video input terminal 12, and the digital video input image from the digital input terminal 15. In the following description of the display device 50 according to the third embodiment of the present invention, description overlapping the first and second embodiments is omitted.

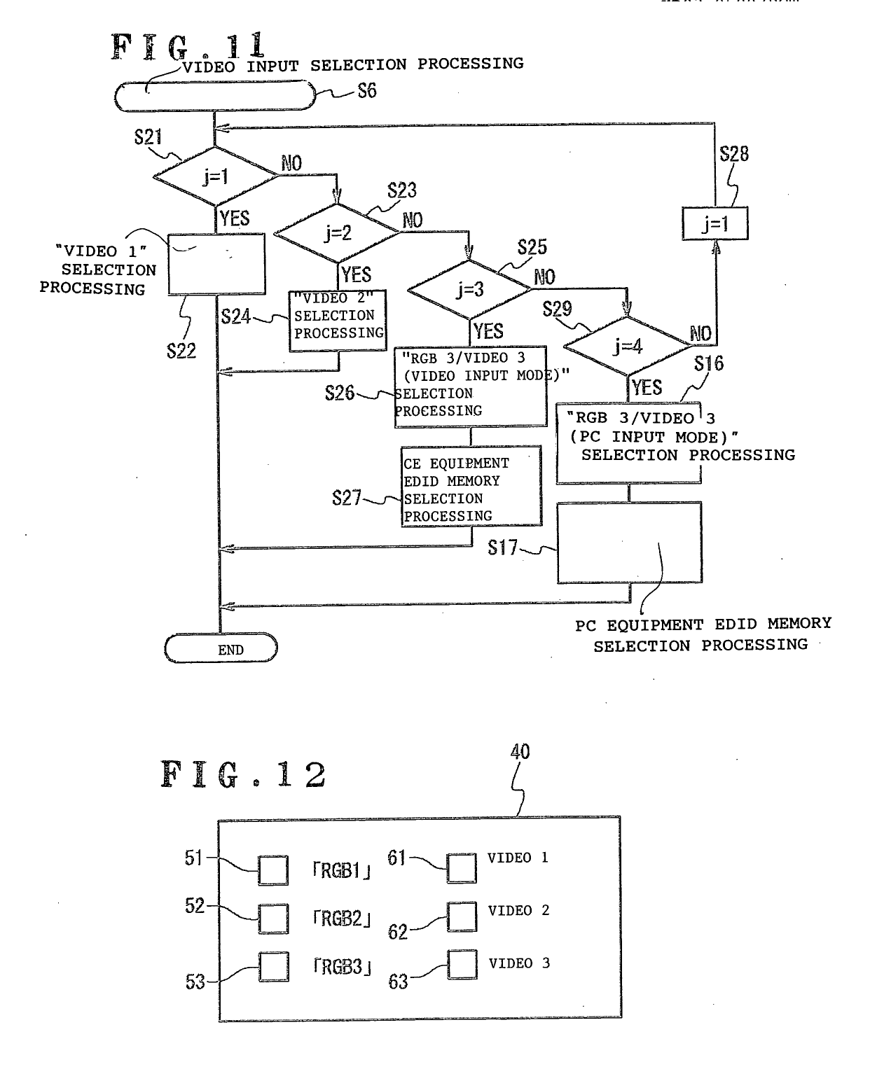

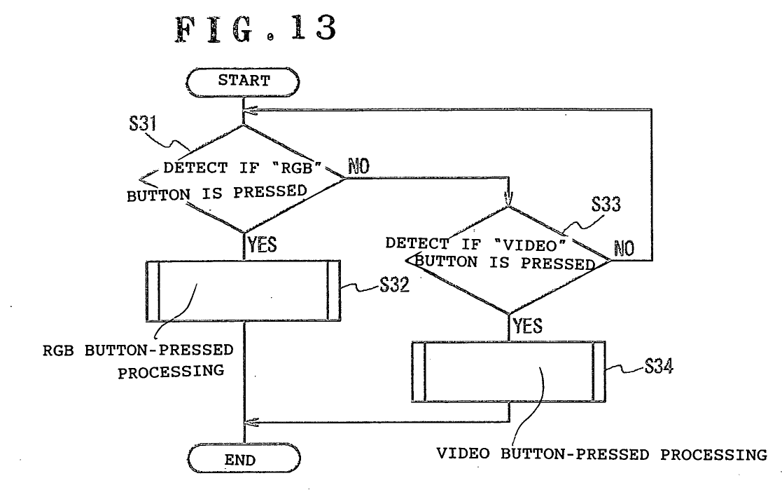

FIG. 12 is a diagram showing the structure of an operation section 40. The operation section 40 is provided with an “RGB 1” button 51, an “RGB 2” button 52, an “RGB 3” button 53, a “VIDEO 1” button 61, a “VIDEO 2” button 62, and a “VIDEO 3” button 63, instead of the “PC INPUT SELECTION” button 41 and the “VIDEO INPUT SELECTION” button 42.

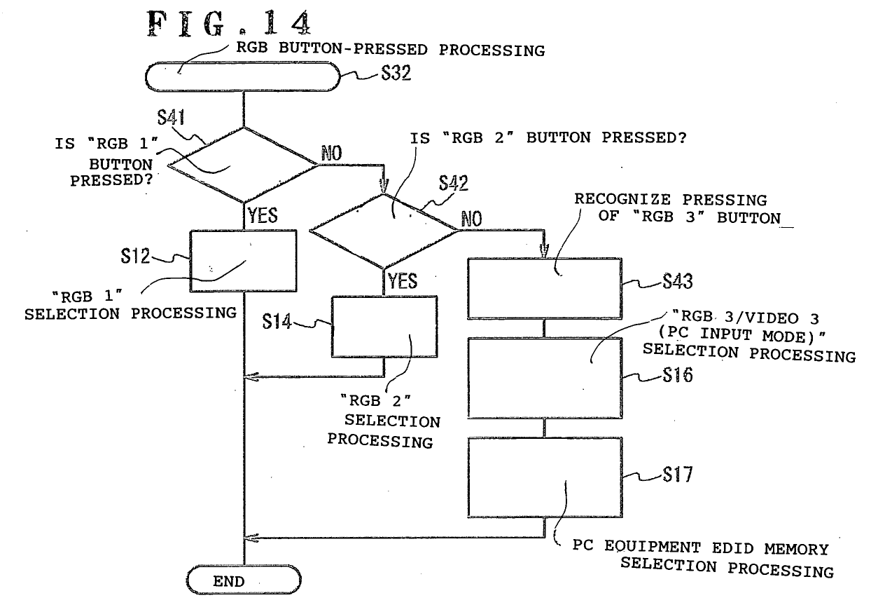

FIG. 13 is a flowchart showing the operation of the display device 50 according to the third embodiment of the present invention. When the user presses any “RGB” button out of the “RGB 1” button 51, the “RGB 2” button 52, and the “RGB 3” button 53 of the operation section 40 (step S31—YES), the display device 50 carries out RGB button-pressed processing (step S32). When the user presses any “VIDEO” button out of the “VIDEO 1” button 61, the “VIDEO 2” button 62, and the “VIDEO 3” button 63 of the operation section 40 (step S31—NO and S33—YES), the display device 50 carries out video button-pressed processing (step S34).

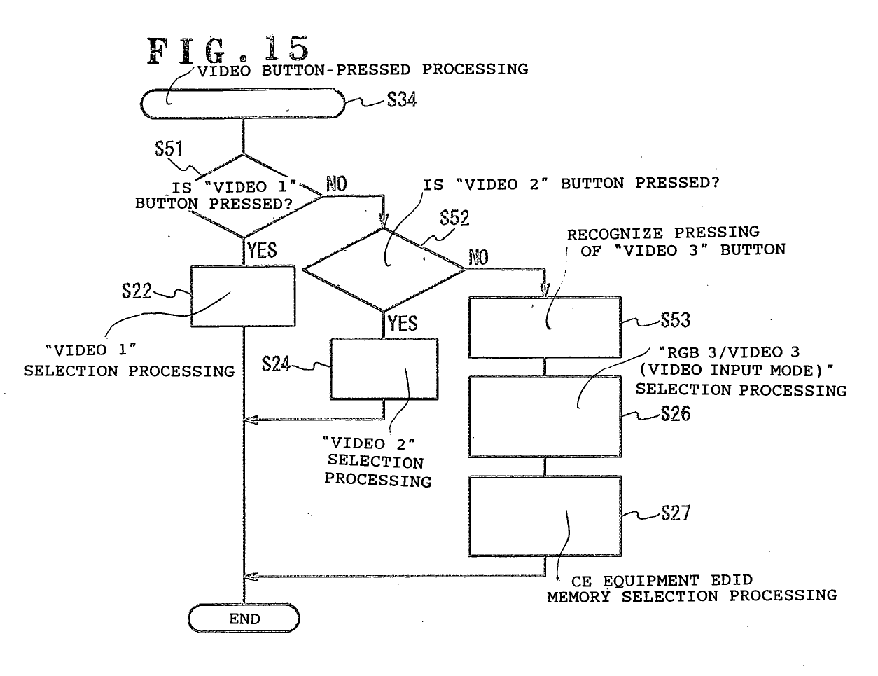

FIG. 14 is a flowchart showing the RGB button-pressed processing (step S32) performed by the display device 50 according to the third embodiment of the present invention. When the user presses the “RGB 1” button 51 of the operation section 40 (step S41—YES), the display control section 22 sends the first analog PC terminal selection signal to the display signal processing section 21. Then, the display device 50 carries out the “RGB 1” selection processing which is the same as that of the first embodiment (step S12).

When the user presses the “RGB 2” button 52 of the operation section 40 (step S41—NO and S42—YES), the display control section 22 sends the second analog PC terminal selection signal to the display signal processing section 21. Then, the display device 50 carries out the “RGB 2” selection processing which is the same as that of the first embodiment (step S14).

When the user presses the “RGB 3” button 53 of the operation section 40 (step S41—NO, S42—NO, and S43), the display control section 22 outputs the digital PC input selection signal to the display signal processing section 21. Then, the display device 50 simultaneously carries out the “RGB 3/VIDEO 3 (PC input mode)” selection processing (step S16) and the PC equipment EDID memory selection processing (step S17), which are the same as those of the first embodiment.

FIG. 15 is a flowchart showing the video button-pressed processing (step S34) performed by the display device 50 according to the third embodiment of the present invention. When the user presses the “VIDEO 1” button 61 of the operation section 40 (step S51—YES), the display control section 22 outputs the first analog video terminal selection signal to the display signal processing section 21. Then, the display device 50 carries out the “VIDEO 1” selection processing which is the same as that of the first embodiment (step S22).

When the user presses the “VIDEO 2” button 62 of the operation section 40 (step S51—NO and S52—YES), the display control section 22 outputs the second analog video terminal selection signal to the display signal processing section 21. Then, the display device 50 carries out the “VIDEO 2” selection processing which is the same as that of the first embodiment (step S24).

When the user presses the “VIDEO 3” button 63 of the operation section 40 (step S51—NO, S52—NO, and S53), the display control section 22 supplies the digital video input selection signal to the display signal processing section 21. Then, the display device 50 simultaneously carries out the “RGB 3/VIDEO 3 (video input mode)” selection processing (step S26) and the CE equipment EDID memory selection processing (step S27), which are the same as those of the first embodiment.

According to the display device 50 of the third embodiment of the present invention, when the user uses the host device (PC equipment) and the digital input terminal 15, the user is only required to operate the “RGB 3” button 53 of the operation section 40. When the user uses the host device (CE equipment) and the digital input terminal 15, the user is only required to operate the “VIDEO 3” button 63 of the operation section 40. According to the display device 50 of the third embodiment of the present invention, therefore, when the user switches between the PC equipment and the CE equipment, the display device 50 directly supplies the proper EDID (EDID for PC equipment or EDID for CE equipment) to the host device (PC equipment or CE equipment). Therefore, in addition to the advantage of the first embodiment, a burden on the user is further reduced, and the display device 50 becomes easier for the user to use.

### Fourth Embodiment

The RGB button-pressed processing (step S32) performed by the display device 50 according to a fourth embodiment of the present invention is different from the third embodiment. Specifically, pressing the “RGB 3” button 53 of the operation section 40 switches the digital PC input image into the digital video input image. The video button-pressed processing (step S34) performed by the display device 50 according to the fourth embodiment of the present invention is also different from the third embodiment. Specifically, pressing the “VIDEO 3” button 63 of the operation section 40 switches the digital video input image into the digital PC input image. In the following description of the display device 50 according to the fourth embodiment of the present invention, description overlapping the third embodiment is omitted.

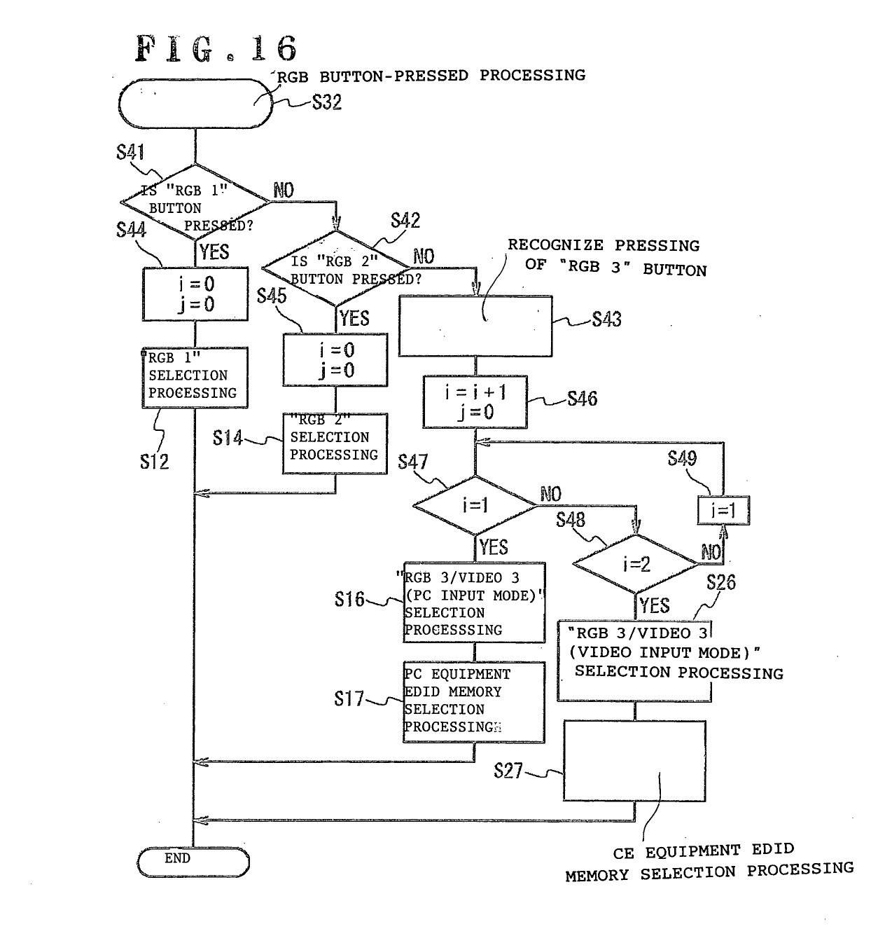

FIG. 16 is a flowchart showing RGB button-pressed processing (step S32) carried out by the display device 50 according to the fourth embodiment of the present invention. When the user presses the “RGB 1” button 51 of the operation section 40 (step S41—YES), the display control section 22 clears the count number i of the PC input counter and the count number j of the video input counter (step S44), and supplies the first analog PC terminal selection signal to the display signal processing section 21. Then, the display device 50 carries out the “RGB 1” selection processing which is the same as that of the first embodiment (step S12).

When the user presses the “RGB 2” button 52 of the operation section 40 (step S41—NO and S42—YES), the display control section 22 clears the count number i of the PC input counter and the count number j of the video input counter (step S45), and supplies the second analog PC terminal selection signal to the display signal processing section 21. Then, the display device 50 carries out the “RGB 2” selection processing which is the same as that of the first embodiment (step S14).

When the user presses the “RGB 3” button 53 of the operation section 40 (step S41—NO, S42—NO, and S43), the display control section 22 increments the count number i of the PC input counter by 1, and clears the count number j of the video input counter (step S46).

When the count number i of the PC input counter is 1, in other words, when the user presses the “RGB 3” button 53 of the operation section 40 once (step S47—YES), the display control section 22 outputs the digital PC input selection signal to the display signal processing section 21. Then, the display device 50 simultaneously carries out the “RGB 3/VIDEO 3 (PC input mode)” selection processing (step S16) and PC equipment EDID memory selection processing (step S17), which are the same as those of the first embodiment.

When the count number i of the PC input counter is 2, in other words, when the user presses the “RGB 3” button 53 of the operation section 40 once more (twice) (step S47—NO and S48—YES), the display control section 22 outputs the digital video input selection signal to the display signal processing section 21. Then, the display device 50 simultaneously carries out the “RGB 3/VIDEO 3 (video input mode)” selection processing (step S26) and the CE equipment EDID memory selection processing (step S27), which are the same as those of the first embodiment.

When the count number i of the PC input counter is 3, in other words, when the user presses the “RGB 3” button 53 of the operation section 40 once more (three times) (step S47—NO and S48—NO), the display control section 22 sets the count number i of the PC input counter at 1 (step S49), and carries out the step S47.

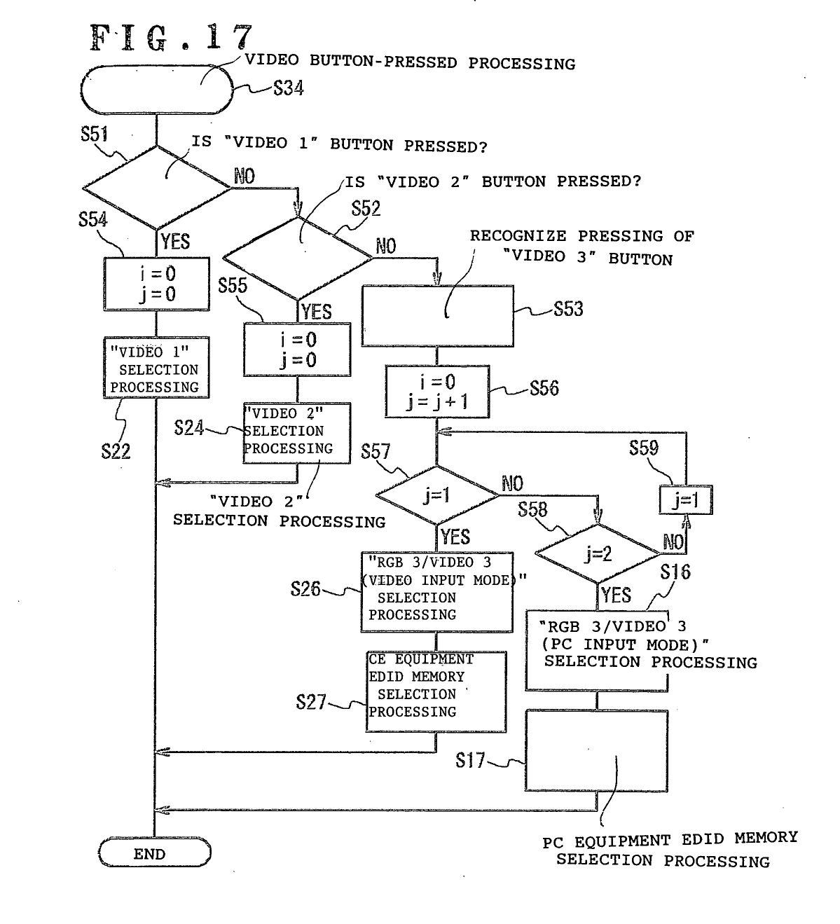

FIG. 17 is a flowchart of video button-pressed processing (step S34) carried out by the display device 50 according to the fourth embodiment of the present invention. When the user presses the “VIDEO 1” button 61 of the operation section 40 (step S51—YES), the display control section 22 clears the count number i of the PC input counter and the count number j of the video input counter (step S54), and outputs the first analog video terminal selection signal to the display signal processing section 21. Then, the display device 50 carries out the “VIDEO 1” selection processing which is the same as that of the first embodiment (step S22).

When the user presses the “VIDEO 2” button 62 of the operation section 40 (step S51—NO and S52—YES), the display control section 22 clears the count number i of the PC input counter and the count number j of the video input counter (step S55), and outputs the second analog video terminal selection signal to the display signal processing section 21. Then, the display device 50 carries out the “VIDEO 2” selection processing which is the same as that of the first embodiment (step S24).

When the user presses the “VIDEO 3” button 63 of the operation section 40 (step S51—NO, S52—NO, and S53), the display control section 22 clears the count number i of the PC input counter, and increments the count number j of the video input counter by 1 (step S56).

When the count number j of the video input counter is 1, in other words, when the user presses the “VIDEO 3” button 63 of the operation section 40 once (step S57—YES), the display control section 22 outputs the digital video input selection signal to the display signal processing section 21. Then, the display device 50 simultaneously carries out the “RGB 3/VIDEO 3 (video input mode)” selection processing (step S26) and the CE equipment EDID memory selection processing (step S27), which are the same as those of the first embodiment.

When the count number j of the video input counter is 2, in other words, the user presses the “VIDEO 3” button 63 of the operation section 40 once more (twice) (step S57—NO and S58—YES), the display control section 22 outputs the digital PC input selection signal to the display signal processing section 21. Then, the display device 50 simultaneously carries out the “RGB 3/VIDEO 3 (PC input mode)” selection processing (step S16) and the PC equipment EDID memory selection processing (step S17), which are the same as those of the first embodiment.

When the count number j of the video input counter is 3, in other words, when the user presses the “VIDEO 3” button 63 of the operation section 40 once more (three times) (step S57—NO and S58—NO), the display control section 22 sets the count number j of the video input counter at 1 (step S59), and carries out the step S57.

The display control section 22 carries out the step S49 and proceeds to the step S47, when the user presses the “RGB 3” button 53 of the operation section 40 three times. It should be noted that the display control section 22 may carry out the step S49 and proceed to the step S47, when the user presses the “RGB 3” button 53 of the operation section 40 for a certain (predetermined) period of time. The display control section 22 carries out the step S59 and proceeds to the step S57, when the user presses the “VIDEO 3” button 63 of the operation section 40 three times. It should be noted that the display control section 22 may carry out the step S59 and proceed to the step S57, when the user presses the “VIDEO 3” button 63 of the operation section 40 for a certain (predetermined) period of time.

The count number j of the video input counter is cleared in the steps S44, S45, S46, S54, and S55 in the foregoing description. It should be noted, however, that the count number j may be held instead of being cleared. The count number i of the PC input counter is cleared in the steps S44, S45, S54, S55, and S56 in the foregoing description. It should be noted, however, that the count number i may be held instead of being cleared.

According to the display device 50 of the fourth embodiment of the present invention, when the user uses the host device (PC equipment) and the digital input terminal 15, the user is only required to operate the “RGB 3” button 53 of the operation section 40. When the user uses the host device (CE equipment) and the digital input terminal 15, the user is only required to operate the “RGB 3” button 53 of the operation section 40 again. When the user uses the host device (CE equipment) and the digital input terminal 15, the user is only required to operate the “VIDEO 3” button 63 of the operation section 40. When the user uses the host device (PC equipment) and the digital input terminal 15, the user is only required to operate the “VIDEO 3” button 63 of the operation section 40 again. According to the display device 50 of the fourth embodiment of the present invention, as described above, the user can switch between the PC equipment and the CE equipment by the same buttons. Therefore, in addition to the advantages of the third embodiment, a burden on the user is further reduced, and the display device 50 becomes easier for the user to use.

As understood from the foregoing description, the display device 50 of the present invention can obtain the proper display signal from the host device.

Also, the display device 50 of the present invention can always select the proper display specifications information, when the user uses the host device and the digital input terminal 15.

Furthermore, the display device 50 of the present invention can reduce a burden on the user, and is easy for the user to use.

1. A display device comprising:
a plurality of input terminals which receive a plurality of display signals, respectively, the plurality of input terminal including a digital input terminal;
a display signal processing section which selects one of the plurality of the display signals received at the plurality of input terminals;
a first memory section which stores first display specifications information;
a second memory section which stores second display specifications information;
a memory shift switch which connects the digital input terminal to either the first memory section or the second memory section; and
a display control section which controls an operation of the display signal processing section and the memory shift switch, wherein:
the first display specifications information is specifications information for the display signal which is introduced into the digital input terminal and the second display specifications information is another specifications information for the display signal which is introduced into the digital input terminal;
the display control section carries out a first operation, in which the display control section controls the display signal processing section so as to select the display signal corresponding to the first display specifications information, and controls the memory shift switch so as to connect the first memory section to the digital input terminal; and
the display control section carries out a second operation, in which the display control section controls the display signal processing section so as to select the display signal corresponding to the second display specifications information, and controls the memory shift switch so as to connect the second memory section to the digital input terminal.

2. The display device according to claim 1, further comprising an operation section which is connected to the display control section and is operated by a user, wherein the operation section has at least one input selection switch to select at least one of the plurality of input terminals, and
the display control section carries out at least one of the first and second operations in accordance with the operation of the at least one input selection switch by the user.

3. The display device according to claim 2, wherein the plurality of input terminals further include at least one analog video input terminal to receive an analog video signal and at least one analog PC input terminal to receive an analog PC signal;
the operation section has a first input selection switch for selecting either the digital input terminal or the at least one analog video input terminal, and a second input selection switch for selecting either the digital input terminal or the at least one analog PC input terminal;
the display control section controls the display signal processing section so as to select the display signal from either the digital input terminal or the at least one analog video input terminal, in accordance with the operation of the first input selection switch by the user; and
the display control section controls the display signal processing section so as to select the display signal from either the digital input terminal or the at least one analog PC input terminal, in accordance with the operation of the second input selection switch by the user.

4. The display device according to claim 3, wherein when the display signal from the digital input terminal is selected in accordance with the operation of the first input selection switch by the user, the display control section carries out the first operation; and
when the display signal from the digital input terminal is selected in accordance with the operation of the second input selection switch by the user, the display control section carries out the second operation.

5. The display device according to one of claims 2 to 4, wherein the operation section is connected to the display control section by radio.

6. The display device according to one of claims 1 to 5, wherein the first display specifications information is EDID (extended display identification data) of consumer electronics equipment, and the second display specifications information is EDID of a personal computer.

7. A display device comprising:
a plurality of input terminals which include one digital input terminal to receive a digital display signal, at least one analog video input terminal to receive an analog video signal, and at least one analog PC input terminal to receive an analog PC signal;
a display signal processing section which selects one of the plurality of input terminals, and carries out signal processing on a display signal input from the selected input terminal in order to display the display signal on a display section in a format suited to the display section;
a first memory section which stores EDID for video;
a second memory section which stores PC equipment EDID;
a memory shift switch which connects the digital input terminal to the first or second memory section; and
an input selection switch which selects one of the plurality of input terminals, wherein the memory shift switch is switched in accordance with a selection result by the input selection switch, and the display signal processing section determines the display signal to be displayed on the display section.

8. A display method for use with a display device which includes a plurality of input terminals to receive a plurality of display signals, respectively, a first memory section which stores first display specifications information, and a second memory section which stores second display specifications information, the plurality of input terminals having a digital input terminal, the display method comprising:
(A) selecting the digital input terminal from the plurality of input terminals, when a user selects the first or second display specifications information;
(B) connecting the first memory section to the digital input terminal when the first display specifications information is selected, and connecting the second memory section to the digital input terminal when the second display specifications information is selected; and
(C) displaying the display signal, which is input from the selected digital input terminal and suited to the first display specifications information, when the first display specifications information is selected, and displaying the display signal, which is input from the selected digital input terminal and suited to the second display specifications information, when the second display specifications information is selected.

9. The display method according to claim 8, wherein the first display specifications information is EDID (extended display identification data) of consumer electronics equipment, and the second display specifications information is EDID of a personal computer.

10. A display method comprising the steps of:
making a user select one input from a plurality of inputs including a digital input;
making the user select one digital equipment group from a plurality of digital equipment groups when the user has selected the digital input;
connecting a memory section which stores display specifications information of the selected digital equipment group to the digital input terminal; and
displaying a display signal which is suited to the display specifications information introduced from the input terminal.
